(19) United States
(12) Patent Application Publication
(10) Pub. No.: US 2025/0145119 A1
(43) Pub. Date: May 8, 2025

(54) DEBRIS MANAGEMENT FOR VEHICLE SENSORS

(71) Applicant: International Truck Intellectual Property Company, LLC, Lisle, IL (US)

(72) Inventor: Robert M. Tourville, Aurora, IL (US)

(73) Assignee: International Truck Intellectual Property Company, LLC, Lisle, IL (US)

(21) Appl. No.: 18/386,706

(22) Filed: Nov. 3, 2023

(51) Int. Cl. B60S 1/56; B60S 1/04; B60S 1/52

(52) U.S. Cl. CPC B60S 1/566; B60S 1/0411; B60S 1/52

(57) ABSTRACT

A debris management system for vehicle sensors includes a sensor disposed on a first side of a transparent cover, the sensor having a field of view through the transparent cover, wherein the transparent cover is configured to move across the field of view of the sensor. A solvent nozzle is disposed on a second side of the transparent cover, wherein the solvent nozzle is configured to spray solvent at a surface of the second side and into the field of view. A wiper is disposed in contact with the surface of the second side.

### FIELD OF THE INVENTION

The present disclosure relates generally to a debris management system for cleaning debris blocking the field of view of vehicle mounted sensors, and more particularly, but without limitation, to such a debris management system that can operate in an indexed mode or a continuous mode.

### BACKGROUND

Sensors are being disposed on surfaces of modern vehicles in ever increasing numbers. Such sensors are distributed all around a vehicle for collecting data on the vehicle surroundings in all directions for use in critical tasks, for example, including autonomous driving modes. It is crucial that such sensors function accurately without being fouled by debris coating the sensor and interfering with optimum sensing. A need therefore exists for a robust and reliable cleaning system that can clean vehicle mounted sensors in any driving environment. It would be useful if such a cleaning system could operate to clean individual sensors as needed while also being able to clean one or more sensors continuously when the vehicle is subjected to a continuously fouling environment.

### SUMMARY OF THE INVENTION

In one aspect of the invention, a debris management system for vehicle sensors comprises a sensor disposed on a first side of a transparent cover, the sensor having a field of view through the transparent cover, wherein the transparent cover is configured to move across the field of view of the sensor. A solvent nozzle is disposed on a second side of the transparent cover, wherein the solvent nozzle is configured to spray solvent at a surface of the second side and into the field of view. A wiper is disposed in contact with the surface of the second side.

In another aspect of the invention, a debris management system for vehicle sensors comprises a sensor disposed on a first side of a transparent cover, the sensor having a field of view through the transparent cover, wherein the transparent cover is configured to move across the field of view of the sensor by rotating around an axis outside of the field of view. A solvent nozzle is disposed on a second side of the transparent cover, wherein the solvent nozzle is configured to spray solvent at a surface of the second side and into the field of view. A wiper is disposed in contact with the surface of the second side.

In a further aspect of the invention, a debris management system for vehicle sensors comprises a sensor disposed on a first side of a transparent cover, the sensor having a field of view through the transparent cover, wherein the transparent cover is configured to move linearly across the field of view of the sensor. A solvent nozzle is disposed on a second side of the transparent cover, wherein the solvent nozzle is configured to spray solvent at a surface of the second side and into the field of view. A wiper is disposed in contact with the surface of the second side.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of an exemplary debris management system according to an embodiment;

FIG. 2 is a schematic side view of the debris management system of FIG. 1 taken generally along the cross-section 2-2 in FIG. 1;

FIG. 3 is a schematic diagram of an exemplary debris management system according to another embodiment;

FIG. 4 is a schematic side view of the debris management system of FIG. 3 taken generally along the cross-section 4-4 in FIG. 3;

FIG. 5 is a schematic diagram of an exemplary debris management system according to yet another embodiment; and

FIG. 6 is a schematic diagram of an exemplary debris management system according to yet a further embodiment.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

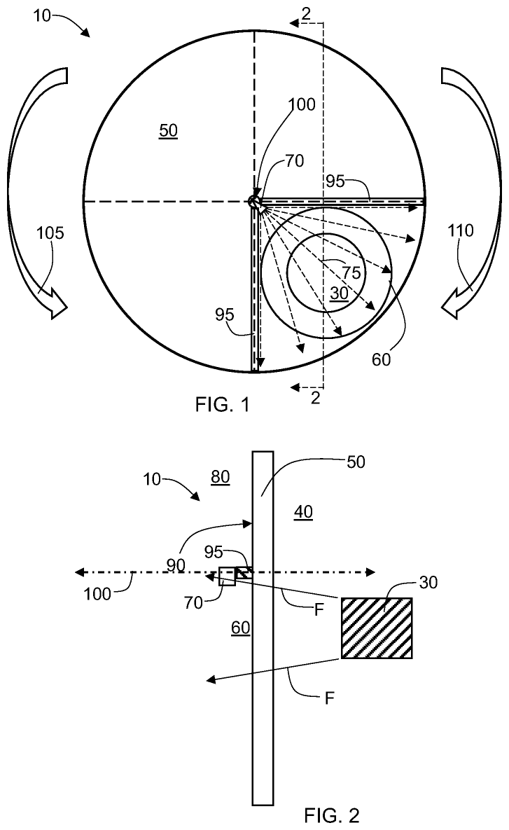

Referring to FIGS. 1-4, exemplary embodiments for a debris management system 10, 20 are illustrated. In these embodiments, the debris management system (DMS) 10, 20 comprises a sensor 30 disposed on a first side 40 of a transparent cover 50. In an embodiment, the sensor 30 has a field of sensing or a field of view 60, denoted by boundary arrows marked F in FIGS. 2 and 4, through the transparent cover 50. In an embodiment, the transparent cover 50 is configured to move across the field of view 60 of the sensor 30. In an embodiment, the sensor 30 is selected from the group of sensors consisting of an optical sensor, a light direction and ranging (LIDAR) sensor, a radio detection and ranging (RADAR) sensor, an infrared sensor, and a sonic sensor.

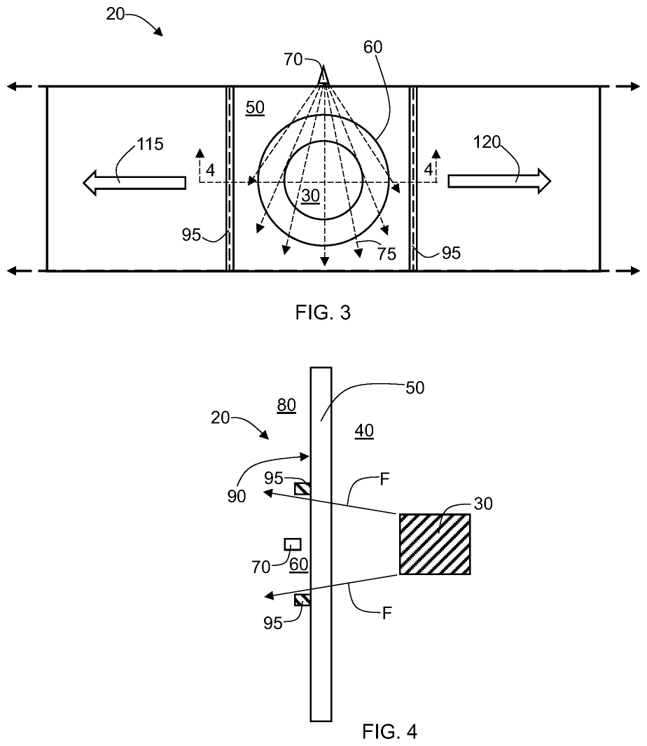

In an embodiment, a solvent nozzle 70 is disposed on a second side 80 of the transparent cover 50. In an embodiment, the solvent nozzle 70 is configured to spray solvent, illustrated by the fan shaped pattern of dashed arrows 75 in FIGS. 1 and 3, at a surface 90 of the second side 80 and into the field of view 60. In an embodiment, a wiper 95 is disposed in contact with the surface 90 of the second side 80.

Referring to FIG. 1, in an embodiment, the transparent cover 50 is configured to rotate around an axis 100 outside of the field of view 60. In an embodiment, the transparent cover 50 is configured to rotate clockwise 110 as viewed from the second side 80 (and as denoted by arrow 110). In an embodiment, the transparent cover 50 is configured to rotate counterclockwise 105 as viewed from the second side 80 (and as denoted by arrow 105). In an embodiment, the transparent cover 50 is configured to rotate in both clockwise 110 and counterclockwise 105 directions as viewed from the second side 80. In an embodiment, the wiper 95 comprises a linear stationary wiper 95 that is disposed proximate to an edge of the field of view 60 and aligned perpendicular to a direction of motion, either clockwise 110 or counterclockwise 105, of the transparent cover 50.

Referring to FIG. 3, in an embodiment, the transparent cover 50 is configured to move linearly. In an embodiment, the transparent cover 50 is configured to move linearly in a first direction 115, for example to the left 115, as viewed from the second side 80 (and as denoted by arrow 115). In an embodiment, the transparent cover 50 is configured to move linearly in a second direction 120 opposite to the first direction 115, for example to the right 120, as viewed from the second side 80 (and as denoted by arrow 120). In an embodiment, the transparent cover 50 is configured to move linearly in both a first direction 115 and a second direction 120 opposite to the first direction 115 as viewed from the second side 80. In an embodiment the wiper 95 comprises a linear stationary wiper 95 that is disposed proximate to an edge of the field of view 60 and aligned perpendicular to a direction of motion, either linearly in a first direction 115 or linearly in a second direction 120, of the transparent cover 50.

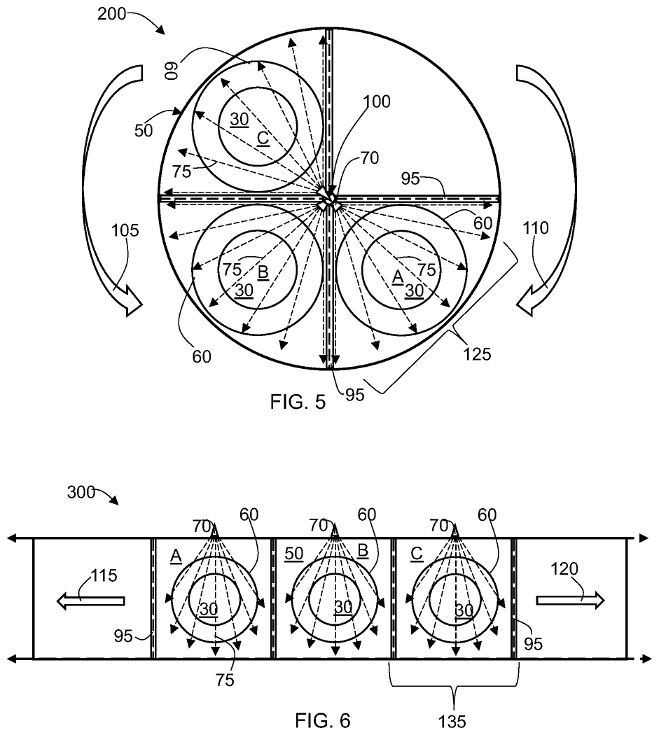

Referring to FIG. 5, in an embodiment, a debris management system 200 includes all of the components described hereinabove for the debris management system 10, but further includes one or more of a set 125 of components, as illustrated in FIG. 5, the set 125 of components comprising a sensor 30, a solvent nozzle 70, and at least one wiper 95 disposed relative to the transparent cover 50 as described above. In an embodiment, the one or more sets 125 of the components is disposed circumferentially around the perimeter of the transparent cover 50. In an embodiment, two of the sets 125 of the components are adjacent to one another, for example, as shown at positions A and B. In another embodiment, two of the sets 125 of the components are disposed across the axis of rotation 100 from one another, for example, as shown at positions A and C. In an embodiment, the arc occupied by each set 125 of the components spans about 90 degrees or a quarter circumferentially of the transparent cover 50 as shown in FIG. 5. In other embodiments, the DMS 200 includes one or more sets 125 of the components wherein each set 125 of the components occupies an arc that spans less than 90 degrees, for example without limitation, an arc that spans about 60 degrees, an arc that spans about 45 degrees, or an arc that spans about 30 degrees.

Referring to FIG. 6, in an embodiment, a debris management system 300 includes all of the components described hereinabove for the debris management system 20, but further includes one or more of a set 135 of components, as illustrated in FIG. 6, the set 135 of components comprising a sensor 30, a solvent nozzle 70, and at least one wiper 95 disposed relative to the transparent cover 50 as described above. In an embodiment, the one or more sets 135 of the components is disposed adjacent to one another, for example, as shown at positions A and B. In another embodiment, two of the sets 135 of the components are disposed separated by a space or gap that is about the size of the set 135 of component, for example, as shown at positions A and C with or without the presence of the set 135 at position B.

Exemplary embodiments of the DMS 10 and 200 as illustrated respectively in FIGS. 1 and 5 are configured to operate in multiple modes of operation. For example, in a first mode of operation, the transparent cover 50 rotates around the axis of rotation 100, where the rotation is indexed to each of the sets 125 of the components. In this mode of operation, the solvent nozzle 70 is configured to spray solvent while the transparent cover 50 executes an indexed rotation, either clockwise 110 or counterclockwise 105, sufficient to move a region of the transparent cover 50 initially within the field of view 60 of a particular sensor 30 to outside of the field of view 60 for that sensor 30. This indexed motion of the transparent cover 50 results in the region being sprayed and wiped by a wiper 95 and another portion of the transparent cover 50 ending up in the field of view of the sensor 30. The indexed motion can be repeated again or multiple times in the same rotational direction or can be reversed and executed in the opposite rotational direction.

Without being held to theory, it is believed that the first mode of operation including rotating the transparent cover 50 while spraying solvent on and wiping off the surface of the transparent cover 50 is useful for spot or intermittent cleaning of debris that has collected on the transparent cover 50 in the line of sight 60 of a sensor 30. In a second mode of operation for the DMS 10, 200, the transparent cover 50 is configured to rotate continuously without of operation the solvent nozzle 70. Without being held to theory, it is believed that the second mode of operation including wiping off the surface of the transparent cover 50 without spraying solvent is useful for environments that continually foul the transparent cover 50 with debris, for example, muddy or slushy environments.

Exemplary embodiments of the DMS 20 and 300 as illustrated respectively in FIGS. 3 and 6 are also configured to operate in multiple modes of operation. For example, in a first mode of operation, the transparent cover 50 moves linearly in a first 115 or a second 120 direction, where the linear motion is indexed to each of the sets 135 of the components. In this mode of operation, the solvent nozzle 70 is configured to spray solvent while the transparent cover 50 executes an indexed linear motion sufficient to move a region of the transparent cover 50 initially within the field of view 60 of view of a particular sensor 30 to outside of the field of view 60 for that sensor 30. This indexed motion of the transparent cover 50 results in the region being sprayed and wiped by a wiper 95 and another portion of the transparent cover 50 ending up in the field of view of the sensor 30. The indexed motion can be repeated again or multiple times in the same linear direction or can be reversed and executed in the opposite linear direction.

Without being held to theory, it is believed that the first mode of operation including linear translation of the transparent cover 50 while spraying solvent on and wiping off the surface of the transparent cover 50 is useful for spot or intermittent cleaning of debris that has collected on the transparent cover 50 in the line of sight 60 of a sensor 30. In a second mode of operation for the DMS 20, 300, the transparent cover 50 is configured to move continuously without of operation the solvent nozzle 70. Without being held to theory, it is believed that the second mode of operation including wiping off the surface of the transparent cover 50 without spraying solvent is useful for environments that continually foul the transparent cover 50 with debris, for example, muddy or slushy environments. In other embodiments, the solvent nozzle 70 described as part of any of the DMS 10, 20, 200, 300 operates to spray solvent independently of whether the transparent cover 50 moves or not.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A debris management system for vehicle sensors operates to move a transparent cover wiped by a stationary wiper through the field of view of one or more vehicle sensors, thereby cleaning the transparent cover of debris collected thereon. The system operates in an indexed mode including a solvent sprayed onto the transparent cover and in a continuous mode without the solvent. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A debris management system for vehicle sensors, the system comprising:
a sensor disposed on a first side of a transparent cover, the sensor having a field of view through the transparent cover, wherein the transparent cover is configured to move across the field of view of the sensor;
a solvent nozzle disposed on a second side of the transparent cover, wherein the solvent nozzle is configured to spray solvent at a surface of the second side and into the field of view; and
a wiper disposed in contact with the surface of the second side.

2. The debris management system of claim 1, wherein the wiper comprises a linear stationary wiper that is disposed proximate to an edge of the field of view and aligned perpendicular to a direction of motion of the transparent cover.

3. The debris management system of claim 1, wherein the transparent cover is configured to rotate around an axis outside of the field of view.

4. The debris management system of claim 3, wherein the solvent nozzle is configured to spray solvent while the transparent cover executes an indexed rotation sufficient to move a region of the transparent cover initially within the field of view to outside of the field of view.

5. The debris management system of claim 3, wherein the transparent cover is configured to rotate in both clockwise and counterclockwise directions as viewed from the second side.

6. The debris management system of claim 3, wherein the transparent cover is configured to move continuously.

7. The debris management system of claim 1, wherein the transparent cover is configured to move linearly.

8. The debris management system of claim 7, wherein the solvent nozzle is configured to spray solvent while the transparent cover executes an indexed linear motion sufficient to move a region of the transparent cover initially within the field of view to outside of the field of view.

9. The debris management system of claim 7, wherein the transparent cover is configured to move linearly in both a first direction and a second direction opposite to the first direction as viewed from the second side.

10. The debris management system of claim 7, wherein the transparent cover is configured to move continuously.

11. A debris management system for vehicle sensors, the system comprising:
a sensor disposed on a first side of a transparent cover, the sensor having a field of view through the transparent cover, wherein the transparent cover is configured to move across the field of view of the sensor by rotating around an axis outside of the field of view;
a solvent nozzle disposed on a second side of the transparent cover, wherein the solvent nozzle is configured to spray solvent at a surface of the second side and into the field of view; and
a wiper disposed in contact with the surface of the second side.

12. The debris management system of claim 11, wherein the wiper comprises a linear stationary wiper that is disposed proximate to an edge of the field of view and aligned perpendicular to a direction of motion of the transparent cover.

13. The debris management system of claim 11, wherein the solvent nozzle is configured to spray solvent while the transparent cover executes an indexed rotation sufficient to move a region of the transparent cover initially within the field of view to outside of the field of view.

14. The debris management system of claim 11, wherein the transparent cover is configured to rotate in both clockwise and counterclockwise directions as viewed from the second side.

15. The debris management system of claim 11, wherein the transparent cover is configured to move continuously.

16. A debris management system for vehicle sensors, the system comprising:
a sensor disposed on a first side of a transparent cover, the sensor having a field of view through the transparent cover, wherein the transparent cover is configured to move linearly across the field of view of the sensor;
a solvent nozzle disposed on a second side of the transparent cover, wherein the solvent nozzle is configured to spray solvent at a surface of the second side and into the field of view; and
a wiper disposed in contact with the surface of the second side.

17. The debris management system of claim 16, wherein the wiper comprises a linear stationary wiper that is disposed proximate to an edge of the field of view and aligned perpendicular to a direction of motion of the transparent cover.

18. The debris management system of claim 16, wherein the solvent nozzle is configured to spray solvent while the transparent cover executes an indexed linear motion sufficient to move a region of the transparent cover initially within the field of view to outside of the field of view.

19. The debris management system of claim 16, wherein the transparent cover is configured to move linearly in both a first direction and a second direction opposite to the first direction as viewed from the second side.

20. The debris management system of claim 16, wherein the transparent cover is configured to move continuously.
